(19) United States
(12) Patent Application Publication
(10) Pub. No.: US 2022/0129448 A1
(43) Pub. Date: Apr. 28, 2022

(54) INTELLIGENT DIALOGUE METHOD AND APPARATUS, AND STORAGE MEDIUM

(71) Applicant: Beijing Baidu Netcom Science Technology Co., Ltd., Beijing (CN)

(72) Inventors: Dongfeng He, Beijing (CN); Bingjin Chen, Beijing (CN); Wanshun Chen, Beijing (CN); Jiayang Tu, Beijing (CN); Yingzhan Lin, Beijing (CN); Shiwei Huang, Beijing (CN)

(73) Assignee: Beijing Baidu Netcom Science Technology Co., Ltd., Beijing (CN)

(21) Appl. No.: 17/647,265

(22) Filed: Jan. 6, 2022

(30) Foreign Application Priority Data
Jun. 30, 2021 (CN) 202110738818.3

(51) Int. Cl. G06F 16/242; G06F 16/2455; G06F 16/22

(52) U.S. Cl. CPC G06F 16/243; G06F 16/24564; G06F 16/2237; G06F 16/24553

(57) ABSTRACT

An intelligent dialogue method and apparatus and medium are provided. The method includes: obtaining a pre-matching result by pre-matching a query to be processed with a table content of a target table; extracting a character segment having a highest matching degree with the attribute value from the query based on the attribute value having the highest matching degree with the query; determining a target attribute value semantically associated with the character segment based on the attribute value of each column attribute; generating a structured query language (SQL) query statement corresponding to the query based on the query, the attribute name of each column attribute, the highest matching level of the attribute name, the highest matching level of the attribute value and the target attribute value; and generating a reply statement based on a result obtained by searching a database based on the SQL query statement.

### CROSS-REFERENCE TO RELATED APPLICATION

The present application is based upon and claims priority to Chinese Patent Application No. 202110738818.3, filed on Jun. 30, 2021, the entirety contents of which are incorporated herein by reference.

### TECHNICAL FIELD

The disclosure generally relates to the field of artificial intelligence techniques, specifically to the fields of natural language processing and deep learning, and in particular to an intelligent dialogue method, an intelligent dialogue apparatus, an electronic device and a storage medium, which can be specifically applied to different intelligent dialogue scenarios.

### BACKGROUND

Q&A table is a technique for asking questions based on the content of the table and obtaining answers to the questions. The technology can include 4 steps: importing table data into a database; analyzing natural language into SQL statements (this process can be called NL2SQL); searching the database based on the SQL statements; and generating reply statements based on results after searching the database. The core step is NL2SQL.

One of the biggest challenges faced by NL2SQL is the generalization of columns and values in the table. In actual business scenarios, users do not understand the information in the table, it is difficult for the user's query to exactly match the columns or values in the table, resulting in SQL parsing failure and unsatisfactory database search results, so that the effect of intelligent dialogue gets worse.

### SUMMARY

The embodiments of the disclosure provide an intelligent dialogue method, an intelligent dialogue apparatus, and a storage medium.

According to embodiments of the present disclosure, an intelligent dialogue method is provided. The method includes: obtaining a pre-matching result by pre-matching a query to be processed with a table content of a target table, in which the target table includes a plurality of column attributes and an attribute value of each column attribute, the pre-matching result includes a highest matching level of an attribute name of each column attribute, a highest matching level of the attribute value, and an attribute value having a highest matching degree with the query; extracting a character segment having a highest matching degree with the attribute value from the query based on the attribute value having the highest matching degree with the query; determining a target attribute value semantically associated with the character segment based on the attribute value of each column attribute; generating a structured query language (SQL) query statement corresponding to the query based on the query, the attribute name of each column attribute, the highest matching level of the attribute name, the highest matching level of the attribute value and the target attribute value; and generating a reply statement based on a result obtained by searching a database based on the SQL query statement.

According to embodiments of the present disclosure, an intelligent dialogue apparatus is provided. The apparatus includes: one or more processors; a memory storing instructions executable by the one or more processors; in which the one or more processors are configured to: obtain a pre-matching result by pre-matching a query to be processed with a table content of a target table, in which the target table includes a plurality of column attributes and an attribute value of each column attribute, the pre-matching result includes a highest matching level of an attribute name of each column attribute, a highest matching level of the attribute value, and an attribute value having a highest matching degree with the query; extract a character segment having a highest matching degree with the attribute value from the query based on the attribute value having the highest matching degree with the query; determine a target attribute value semantically associated with the character segment based on the attribute value of each column attribute; generate a structured query language (SQL) query statement corresponding to the query based on the query, the attribute name of each column attribute, the highest matching level of the attribute name, the highest matching level of the attribute value and the target attribute value; and generate a reply statement based on a result obtained by searching a database based on the SQL query statement.

According to embodiments of the present disclosure, a non-transitory computer-readable storage medium storing computer instructions is provided. The computer instructions are configured to cause a computer to execute an intelligent dialogue method. The method includes: obtaining a pre-matching result by pre-matching a query to be processed with a table content of a target table, in which the target table includes a plurality of column attributes and an attribute value of each column attribute, the pre-matching result includes a highest matching level of an attribute name of each column attribute, a highest matching level of the attribute value, and an attribute value having a highest matching degree with the query; extracting a character segment having a highest matching degree with the attribute value from the query based on the attribute value having the highest matching degree with the query; determining a target attribute value semantically associated with the character segment based on the attribute value of each column attribute; generating a structured query language (SQL) query statement corresponding to the query based on the query, the attribute name of each column attribute, the highest matching level of the attribute name, the highest matching level of the attribute value and the target attribute value; and generating a reply statement based on a result obtained by searching a database based on the SQL query statement.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of an intelligent dialogue method according to an embodiment of the disclosure.

FIG. 2 is a schematic diagram of a semantic matching model according to an embodiment of the disclosure.

FIG. 3 is a flowchart of pre-matching processing according to an embodiment of the disclosure.

FIG. 4 is a diagram of a dictionary tree according to an embodiment of the disclosure.

FIG. 5 is a diagram of a pre-matching result according to an embodiment of the disclosure.

FIG. 6 is a flowchart of a SQL query statement generating method according to an embodiment of the disclosure.

FIG. 7 is a flowchart of another SQL query statement generating method according to an embodiment of the disclosure.

FIG. 8 is a schematic diagram of generating a SQL query statement according to an embodiment of the disclosure.

FIG. 9 is a block diagram of an intelligent dialogue apparatus according to an embodiment of the disclosure.

FIG. 10 is a block diagram of another intelligent dialogue apparatus according to an embodiment of the disclosure.

FIG. 11 is a block diagram of another intelligent dialogue apparatus according to an embodiment of the disclosure.

FIG. 12 is a block diagram of an electronic device for implementing an intelligent dialogue method according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

It should be noted that one of the biggest challenges faced by the NL2SQL is the generalization of column (column name) and value (attribute value). In actual business scenarios, many users do not understand the information of the table, the query information (query) raised by users is difficult to completely match the columns or values in the table, resulting in SQL parsing failure. For example, the user's query is “what are the candidates whose physical examination result is qualified”, and the value corresponding to physical examination result” of the column in the table is “standard” or “substandard”. Semantically, “qualified” has the same meaning as “standard”, the two words do not match literally and cannot be parsed literally. Since the effect of the SQL statement generating model in the related art depends on the quality of naming the column. When the name of the column cannot fully reflect the meaning of the column, the model will not be able to make correct predictions, resulting in SQL parsing failure, which leads to unsatisfactory database search results and poor intelligent dialogue effects.

Based on the above problems, the present disclosure provides an intelligent dialogue method, an intelligent dialogue apparatus, an electronic device and a storage medium. The disclosure can enable the NL2SQL technology to have the generalization ability of columns and values, so that the user's query can be completely matched with the columns or values in the table, and the success rate of SQL parsing is improved, thereby improving the accuracy rate of database search results, and improving the effect of intelligent dialogue. In detail, the intelligent dialogue method, the intelligent dialogue apparatus, an electronic device and a storage medium of the embodiments of the disclosure are described below with reference to the accompanying drawings.

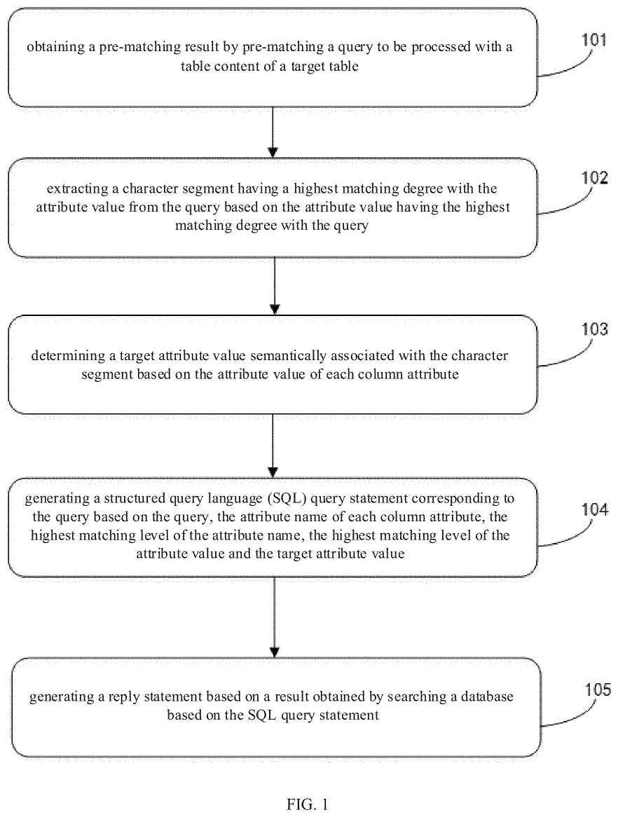

FIG. 1 is a flowchart of an intelligent dialogue method according to an embodiment of the disclosure. As shown in FIG. 1, the intelligent dialogue method includes the following steps.

In step 101, a pre-matching result is obtained by pre-matching a query to be processed with a table content of a target table.

For example, assuming that the intelligent dialogue method of the embodiments of the disclosure can provide a user with a query input interface, through which the query input by the user can be obtained, and the query input by the user is used as the query to be processed. It should be noted that the form of the query input by the user may be in the form of voice or text. When the query input by the user is in the form of voice, the voice input by the user may be recognized and converted into corresponding text information.

In an embodiment, the target table includes a plurality of column attributes and an attribute value of each column attribute. It should be noted that the target table corresponds to the query. The target table may be a table located in a database used for searching the database. In other words, the answer information corresponding to the query may be obtained based on the content of the target table.

In this step, the query to be processed can be pre-matched with the dictionary tree corresponding to the target table to obtain the pre-matching result. The pre-matching result may include a highest matching level of an attribute name of each column attribute, a highest matching level of the attribute value, and an attribute value having a highest matching degree with the query.

That is, the dictionary tree corresponding to the target table is matched with the query, and the highest matching level of the attribute name of each column attribute, the highest matching level of the attribute value, and the attribute value having the highest matching degree with the query are obtained by matching from the plurality of attribute names and attribute values in the target table.

It should be noted that the dictionary tree may be established based on the content of the target table. The feature of the dictionary tree is that the time complexity of retrieving a string of length m is O(m), and its query performance has nothing to do with the number of strings in the set, which can achieve efficient retrieval and matching when there are a lot of contents in the table.

In step 102, a character segment having a highest matching degree with the attribute value is extracted from the query based on the attribute value having the highest matching degree with the query.

For example, suppose the query is “What are the models of brand AAAA”, the values listed as “Brand Name” in the target table are “AAAAA”, “AABBCC” and the like. The pre-matching is performed based on the query and the dictionary tree of the target table, to obtain the value “AAAAA” having the highest matching degree with the query. According to the value “AAAAA” having the highest matching degree with the query, the character segment having the highest matching degree with the value can be extracted from the query as “AAAA”.

In step 103, a target attribute value semantically associated with the character segment is determined based on the attribute value of each column attribute.

Optionally, when parsing the table information, all the values in the table are calculated in advance through the semantic matching model to calculate vector representations, and the vector representations are stored in a vector library. When extracting the character segment from the query, the semantic matching model can be configured to calculate the vector representations of the character segment, and the vector representations of the character segment can be used to index the most similar vector representations and its corresponding values in the vector library, the retrieved values are determined as the target values semantically associated with the character segment. Therefore, the segments in the query are mapped to the actual values based on the semantic information, to solve the problem of inaccurate literal matching.

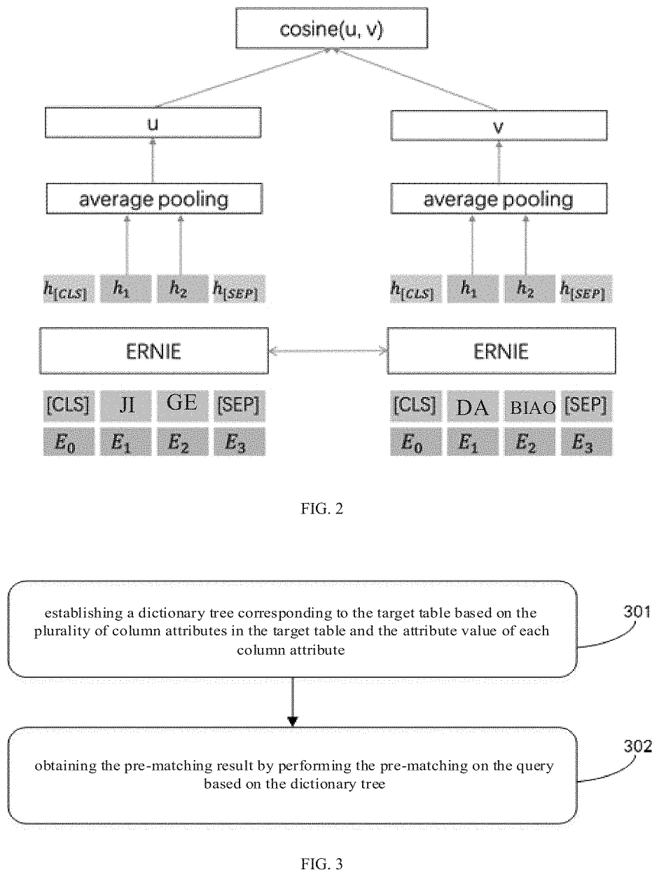

It should be noted that, in the embodiments of the disclosure, the semantic matching model may be pre-trained. In order to map the extracted character segments to the actual values in the target table according to the semantics, the disclosure constructs the semantic matching model based on the Sentence-BERT (a twin network that can quickly calculate sentence similarity) structure. FIG. 2 is a schematic diagram of a semantic matching model. The input of the semantic matching model is two sequences, and the representation of each sequence is “[CLS] value [SEP]”. The two sequences are respectively input into an Ernie model shared by two weights, and the value representations are obtained. After value tokens of the two sequences are processed by average pooling, two vectors u and v in the same dimension are obtained, and the cosine distance of the vectors u and v is calculated as the semantic similarity of the two values.

It should also be noted that the training samples used to train the semantic matching model may include positive samples and negative samples. The positive sample is two characters with the same semantic but have literal deviation, and the negative sample is two characters with different semantics. The positive sample can be constructed through thesaurus or character rewriting. The construction of the negative sample is divided into two stages. In the first stage, the negative sample is constructed by random selection. The disclosure uses the positive sample and the negative sample constructed in the first stage to train an initial semantic matching model. In the second stage, the disclosure uses the first version of the semantic matching model to screen out negative samples with high similarity, that is, difficult negative samples. The disclosure uses positive samples and difficult negative samples to train a final semantic matching model.

In step 104, a structured query language (SQL) query statement corresponding to the query is generated based on the query, the attribute name of each column attribute, the highest matching level of the attribute name, the highest matching level of the attribute value and the target attribute value.

In the embodiments of the disclosure, a trained SQL statement generation model may be used to generate the SQL query statement corresponding to the query. For example, according to the query, the attribute name of each column attribute, the highest matching level of the attribute name, the highest matching level of the attribute value, and the target attribute value can be spliced as input, and the input sequence can be a corresponding vector expression. The vector expression corresponding to the input sequence is input to the trained SQL statement generation model, to obtain the SQL query statement corresponding to the query.

In step 105, a reply statement is generated based on a result obtained by searching a database based on the SQL query statement.

Optionally, when the SQL query statement corresponding to the query is obtained, the database can be searched according to the SQL query statement, to obtain a result obtained by searching the database. The corresponding reply statement is generated based on the result and a corresponding reply statement template. Optionally, the reply statement is provided to the user in at least one display form such as voice broadcast and text display.

According to the intelligent dialogue method of the embodiments of the disclosure, a character segment is extracted from the query by pre-matching the query with the content of the target table, based on the attribute value with the highest matching level with the query in the result. Based on the character segment, the real value name semantically associated with the character segment is determined, and the SQL query statement corresponding to the query is generated based on the attribute name of each column attribute, the highest matching level of the attribute name, the query and the real value name in the result, so that the success rate of SQL parsing can be greatly improved, the accuracy rate of library search results can be improved and the effect of intelligent dialogue can be enhanced.

It is noted that in order to improve the retrieval matching efficiency and a hit rate of the columns in the table, and further improve the success rate of the SQL parsing, the dictionary tree corresponding to the target table may be used to pre-match with the query. Optionally, as shown in FIG. 3, obtaining the pre-matching result by pre-matching the query to be processed with the table content of the target table includes the following steps.

In step 301, a dictionary tree corresponding to the target table is established based on the plurality of column attributes in the target table and the attribute value of each column attribute.

In embodiments of the disclosure, each node in the dictionary tree includes a matching type, a matching level and a complete character string corresponding to the node. For example, in the preprocessing stage, a dictionary tree is established using all the attributes of the target table and the value of each attribute. Each column attribute and the attribute value of the column attribute are determined as an independent dictionary tree, and for each string of all the column attributes of the target table and the attribute values of each column attribute, substrings from different starting positions to the end are extracted, and all these substrings are inserted into the corresponding dictionary tree, and the matching level and matching type of each node of the dictionary tree are obtained.

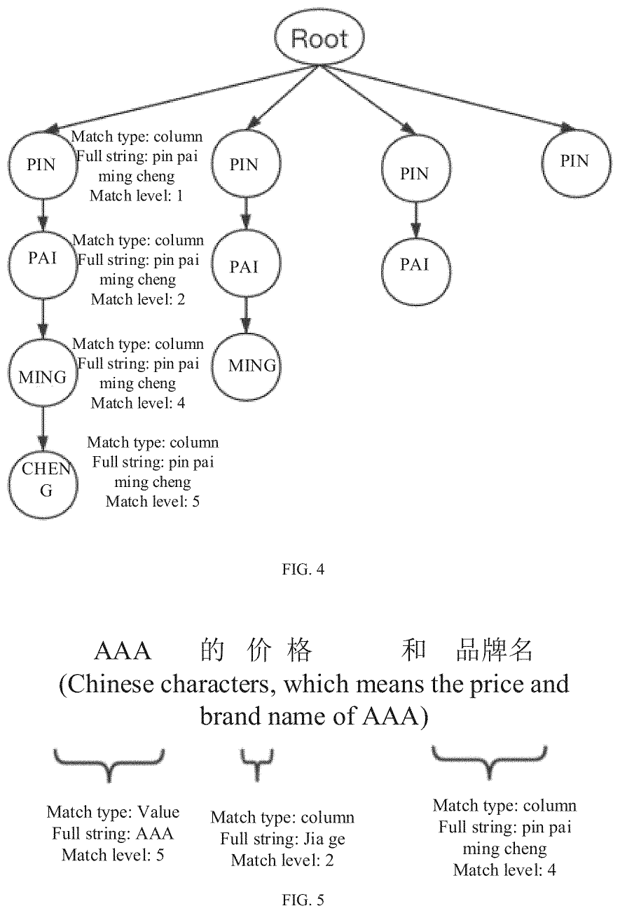

For example, as shown in FIG. 4, the substrings of the column “Brand Name” include “pin pai ming cheng”, “pai ming cheng”, “ming cheng” and “cheng”. Different substrings have different matching degrees with the original string (e.g., “Brand Name” matches completely with the original string, while “cheng” has only one matching character). These substrings are inserted into the dictionary tree corresponding to “Brand Name”, and the matching level and matching type (attribute names or values of the column) are obtained for each node of the dictionary tree. The matching level can be divided into 6 levels according to the matching degree of different character strings with the original string, where 0 means “no match”, 5 means “perfect match”, and the matching degree increases from 1 to 4. As shown in FIG. 4, each node in this dictionary tree includes the matching type, the matching level and the complete string corresponding to each node.

In step 302, the pre-matching result is obtained by performing the pre-matching on the query based on the dictionary tree.

In an implementation, a matching operation is performed backwards on the dictionary tree starting with a character in the query, until the matching operation is unable to continue, and the maximum matching character string interval starting from the character and a corresponding matching level are obtained. An overlapping character string interval list and a corresponding matching level list are obtained after completing the matching operation for each character of the query. A non-overlapping maximum coverage interval list corresponding to each matching level is obtained by de-overlapping character string intervals corresponding to each matching level in descending order of the matching level. The pre-matching result is obtained based on the non-overlapping maximum coverage interval list corresponding to each matching level.

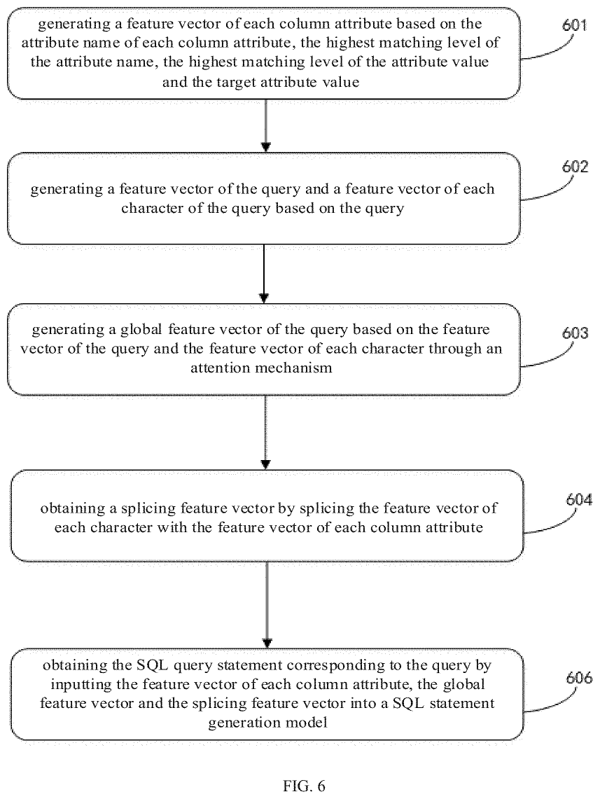

For example, the dictionary tree is used to perform maximum matching on the query. A character in the query is used as the starting point, and the matching is performed backward on the dictionary tree until the matching operation is unable to continue, and the maximum matching string interval starting with a character in the query and the corresponding matching level can be obtained. When the matching operation is done for each character in the query, the overlapping character string interval list and the corresponding matching level list are obtained. A non-overlapping maximum coverage interval list corresponding to each matching level is obtained by de-overlapping character string intervals corresponding to each matching level in descending order of the matching level. For intervals already occupied by high matching levels, low matching levels will not be able to occupy the intervals. Finally, the non-overlapping string interval list and the corresponding matching level can be obtained. For example, as shown in FIG. 5, taking the example of the query “values and brand names of AAA”, the pre-matching result is obtained after pre-matching the query with the dictionary tree of the corresponding target table, where the pre-matching result can include a highest matching level of each column, a highest matching level of the value, and a value having a highest matching degree with the query.

It can be seen that the corresponding dictionary tree is established using the table content of the target table, and the dictionary tree is characterized by the time complexity of O(m) for retrieving strings of length m. The query performance is independent of the number of strings in the set, which can achieve efficient retrieval matching when the table contents are large. The dictionary tree is used for pre-matching with problem advancement, which improves the retrieval matching efficiency, increases the hit rate of columns in the table, and further improve the success rate of SQL parsing.

It should be noted that the SQL statement generation model is used to generate SQL query statements corresponding to the query. For example, the matching features of the query and the table information can be incorporated into the model to enhance the expressive ability of the model. For example, the value with the highest matching degree for each column is added to the model, so that the model can no longer only rely on naming the column to predict the SQL operation for each column, but also refer to the information in the value, the accuracy rate is guaranteed even when the column name is missing. Optionally, as shown in FIG. 6, generating the SQL query statement corresponding to the query based on the query, the attribute name of each column attribute, the highest matching level of the attribute name, the highest matching level of the attribute value, and the target attribute value includes the following steps.

In step 601, a feature vector of each column attribute is generated based on the attribute name of each column attribute, the highest matching level of the attribute name, the highest matching level of the attribute value and the target attribute value.

Optionally, for each column attribute, the attribute name, the highest matching level of the attribute name, the highest matching level of the attribute value and the target attribute value of the column attribute are spliced, and the sequence obtained after the splicing is transformed into a vector representation using the Ernie model. That is, each column attribute sequence obtained after the splicing is input to the Ernie model, and the feature vector representation corresponding to each column attribute sequence obtained after the splicing is obtained. The feature vector representation is the feature vector of each column attribute.

In step 602, a feature vector of the query and a feature vector of each character of the query are generated based on the query.

Optionally, the query is input to the Ernie model to obtain a feature vector of the query and a feature vector of each character of the query.

In step 603, a global feature vector of the query is generated based on the feature vector of the query and the feature vector of each character through an attention mechanism.

Optionally, based on the attention mechanism, a corresponding attention feature vector is generated based on the feature vector of the query and the feature vector of each character, and a global feature vector of the query is generated based on the feature vector of the query and the attention feature vector.

In step 604, a splicing feature vector is obtained by splicing the feature vector of each character with the feature vector of each column attribute.

In step 605, the SQL query statement corresponding to the query is obtained by inputting the feature vector of each column attribute, the global feature vector and the splicing feature vector into a SQL statement generation model.

In some embodiments of the disclosure, the SQL statement generation model may include a query field subtask, a query field determination condition subtask, a query field determination condition symbol subtask, a query field determination condition quantity subtask, a query field aggregation function subtask, a query quantity subtask, a problem determination condition quantity subtask, a sequence labeling subtask, and a determination condition logical connector subtask. For example, the query field sub task can be an S-COL sub-task, the role of this S-COL sub-task is: whether the column is a select column or not.

The query field determination condition subtask can be a W-COL subtask, and the role of this W-COL subtask is: whether the column is a where column.

The query field determination condition subtask can be a W-OP subtask, and the role of this W-OP subtask is: a condition symbol of where column.

The query field determination condition quantity subtask can be W-NUM-col subtask, and the role of this W-NUM-col subtask is: the number of where conditions corresponding to where column.

The query field aggregation function subtask can be a W-AGG subtask, the role of this W-AGG subtask is: an aggregate function for select column.

The query quantity subtask can be S-NUM subtask, the role of this S-NUM subtask is: select quantity.

The problem determination condition quantity subtask may be W-NUM-all subtask, and the role of this W-NUM-all subtask is: where condition quantity of the query quantity subtask.

The sequence labeling subtask can be W-VAL-tag subtask, and the role of this W-VAL-tag subtask is: whether this query token is the value of where column.

The determination condition logical connector subtask may be a CONN subtask, which serves as a logical connector between where conditions.

In this embodiment, the feature vector of each column attribute, the global feature vector, and the splicing feature vector can be input to the SQL statement generation model. Each subtask in the SQL statement generation model is predicted using the corresponding feature vector, to obtain the prediction result corresponding to each subtask, and the SQL query statement corresponding to the query can be generated based on the prediction result corresponding to each subtask.

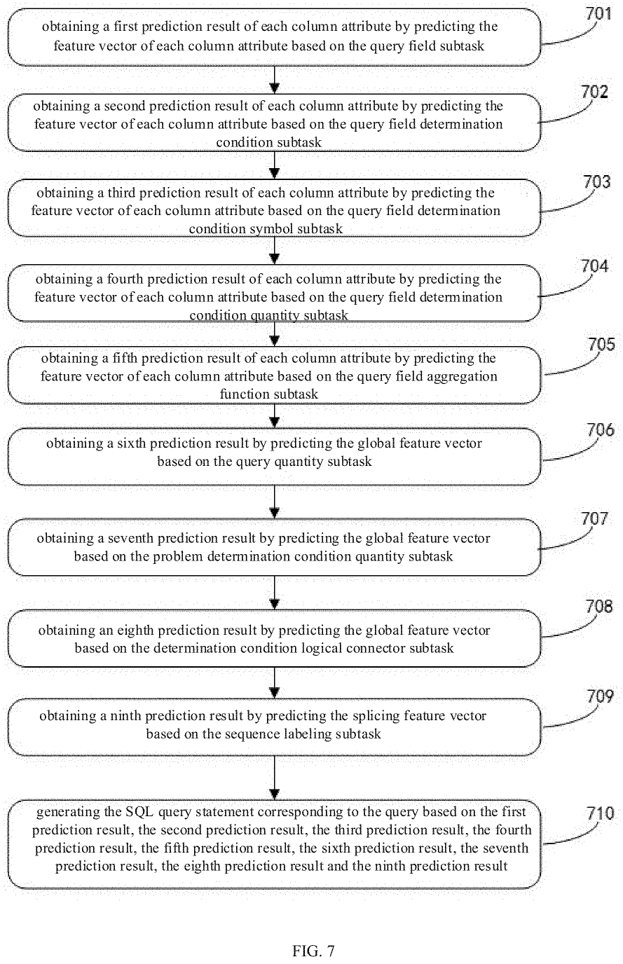

In an implementation, as shown in FIG. 7, obtaining the SQL query statement corresponding to the query by inputting the feature vector of each column attribute, the global feature vector and the splicing feature vector into the SQL statement generation model, includes the following steps.

In step 701, a first prediction result of each column attribute is obtained by predicting the feature vector of each column attribute based on the query field subtask.

In step 702, a second prediction result of each column attribute is obtained by predicting the feature vector of each column attribute based on the query field determination condition subtask.

In step 703, a third prediction result of each column attribute is obtained by predicting the feature vector of each column attribute based on the query field determination condition symbol subtask.

In step 704, a fourth prediction result of each column attribute is obtained by predicting the feature vector of each column attribute based on the query field determination condition quantity subtask.

In step 705, a fifth prediction result of each column attribute is obtained by predicting the feature vector of each column attribute based on the query field aggregation function subtask.

In step 706, a sixth prediction result is obtained by predicting the global feature vector based on the query quantity subtask.

In step 707, a seventh prediction result is obtained by predicting the global feature vector based on the problem determination condition quantity subtask.

In step 708, an eighth prediction result is obtained by predicting the global feature vector based on the determination condition logical connector subtask.

A labeling probability of query token relative to each column can be obtained from the eighth prediction result, and the consecutive strings with labeling probability greater than 0.5 can be extracted as the candidate values of the column, and an average probability is used as a score of the values.

It is noted that in the embodiments of the disclosure, the probability corresponding to a different number of values in each column can be obtained from the third prediction result. The number of values in each column can be determined according to the following formula:

$${arg max}_{n} \frac{{\sum }_{i = 1}^{n} ln ( {score}_{i} + ϵ )}{n} + ln ( {p}_{n} ) ;$$

where n represents the number of column attributes of the column, scoreᵢ is the i^{th} largest column attribute score, pₙ is the number of column attributes having the probability n. To ensure that the formula is a small positive number, the formula is actually selected to determine the number of column attributes having the largest probability of combination of the probabilities of the two subtasks, i.e., the determination condition logical connector subtask and the query field determination condition symbol subtask. After obtaining the number of column attributes n for each column, the n column attributes with the largest score are selected from the candidate column attribute list for each column are determined as the column attributes.

In step 709, a ninth prediction result is obtained by predicting the splicing feature vector based on the sequence labeling subtask.

In step 710, the SQL query statement corresponding to the query is generated based on the first prediction result, the second prediction result, the third prediction result, the fourth prediction result, the fifth prediction result, the sixth prediction result, the seventh prediction result, the eighth prediction result and the ninth prediction result.

Optionally, a candidate query value of each column attribute is determined based on the ninth prediction result. A number of values of each column attribute is determined based on the fourth prediction result and the ninth prediction result. A target query value of each column attribute is determined based on the number of values and the candidate query value of each column attribute. A number of select and a corresponding select column list are determined based on the first prediction result and the sixth prediction result. A number of where and a corresponding where column list are determined based on the second prediction result and the seventh prediction result. A where column condition character is determined based on the third prediction result. A select column aggregation function is determined based on the fifth prediction result. A logical connector of the where column is determined based on the eighth prediction result. The SQL query statement corresponding to the query is generated based on the target query value of each column attribute, the number of select and the select column list, the number of where and the where column list, the where column condition character, the select column aggregation function, and the logical connector of the where column.

For example, as shown in FIG. 8, the disclosure, based on the Ernie model, takes the query (i.e., the query described above) and columns (i.e., the attribute name of each column attribute described above), the highest column matching level (i.e., the highest matching level of attribute name of each column attribute described above), the highest value matching level (i.e., the highest matching level of the attribute value described above), and the value having the highest matching level (i.e., the target attribute value) are spliced as the input. The specific input sequence is as follows:

[CLS] query [SEP] [C], . . . [V], . . . [CM] [VM] [SEP] [C], . . . [V], . . . [CM] [VM] [SEP] . . . [SEP].

where [C] is a token of the i^{th} column, . . . [CLS] is the column token of the i^{th} column, [V] is a special symbol for a value of the i^{th} column, . . . [CM] is the special symbol converted from the highest column matching level of the i^{th} column, [VM] is the special symbol converted from the highest value matching level of the i^{th} column. The special symbol [SEP] is used to separate the query from the columns, and the column from the columns.

Different parts of the input sequence are distinguished using different type embeddings, where the query is category 0, string column is category 1, numeric column is category 2, value is category 3, special symbols [CM], [VM] are category 4, and special symbols [SEP], [PAD] are category 5. The different type embeddings can help the model to distinguish different components in the input sequence.

The query token (i.e., each character in the above query) is spliced with the [CLS] as the query representation by attentive pooling the resources of [CLS] (i.e., the above global feature vector). For each column, the attribute name ([C]), the target attribute value ([V]), the highest matching level of the column name ([CM]), and the highest matching level of the attribute value ([VM]) are spliced as the representation of the column. The query token and [C], [V], [CM] and [VM] of each column are spliced as the value representation of the token for the column.

It is noted that in this disclosed embodiments, the query representation is used to predict three subtasks W-NUM-all, S_NUM, and CONN, all three of which are multi-classification tasks, trained using cross-entropy loss. The denote of each column is used to predict five subtasks S-COL, W-COL, W-OP, W-AGG, and W-NUM-col, where W-OP, W-AGG, and W-NUM-col are multi-classification tasks using cross-entropy loss, and S-COL and W-COL are defined as sorting tasks using KL scatter (relative entropy) as loss, so that all columns can be optimized simultaneously. The value of each column indicates the predicted W-VAL-tag subtask, where this subtask can be defined as a 0/1 binary sequence labeling task, using cross-entropy loss.

It can be seen that the disclosure can fully integrate the matching features of query and table information into the model, to enhance the expressive ability of the model. The value having a highest matching degree in each column is added to the model, so that the model no longer rely on the column names to predict the SQL operation of each column, but also refer to the information in the value, and a certain accuracy can be guaranteed even when the column name is missing. In addition, the disclosure improves the value extraction method, and can extract multiple values of a single column at the same time. In addition, the disclosure has semantic retrieval capabilities, and can map fragments of the query to actual values based on the semantic information, which solves the problem of insufficient literal matching.

In order to implement the above embodiments, the disclosure also provides an intelligent dialogue apparatus.

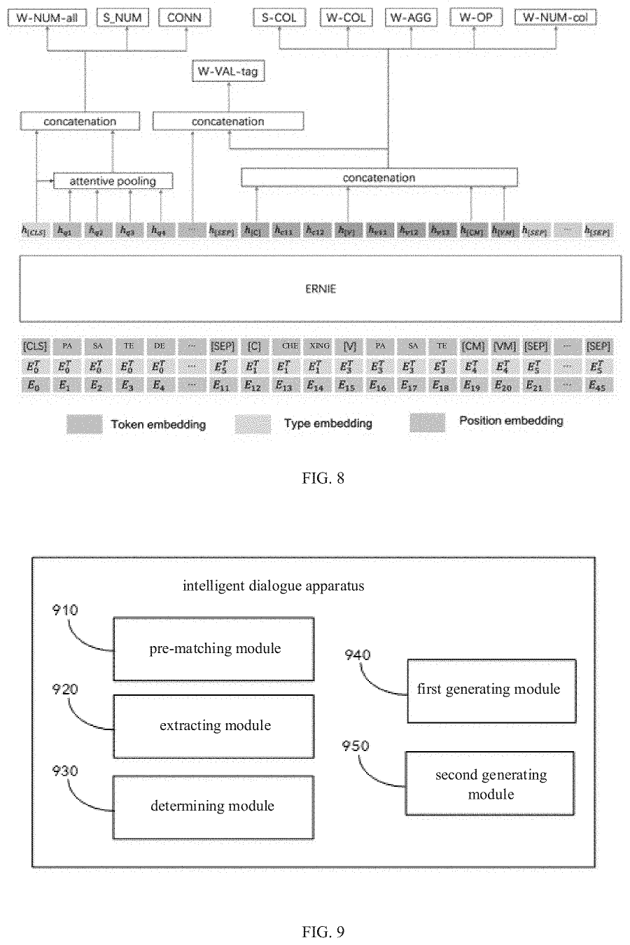

FIG. 9 is a block diagram of an intelligent dialogue apparatus according to an embodiment of the disclosure. As shown in FIG. 9, the intelligent dialogue apparatus may include: a pre-matching module 910, an extracting module 920, a determining module 930, a first generating module 940, and a second generating module 950.

The pre-matching module 910 is configured to obtain a pre-matching result by pre-matching a query to be processed with a table content of a target table. The target table includes a plurality of column attributes and an attribute value of each column attribute, the pre-matching result includes a highest matching level of an attribute name of each column attribute, a highest matching level of the attribute value, and an attribute value having a highest matching degree with the query.

The extracting module 920 is configured to extract a character segment having a highest matching degree with the attribute value from the query based on the attribute value having the highest matching degree with the query.

The determining module 930 is configured to determine a target attribute value semantically associated with the character segment based on the attribute value of each column attribute.

The first generating module 940 is configured to generate a structured query language (SQL) query statement corresponding to the query based on the query, the attribute name of each column attribute, the highest matching level of the attribute name, the highest matching level of the attribute value and the target attribute value.

The second generating module 950 is configured to generate a reply statement based on a result obtained by searching a database based on the SQL query statement.

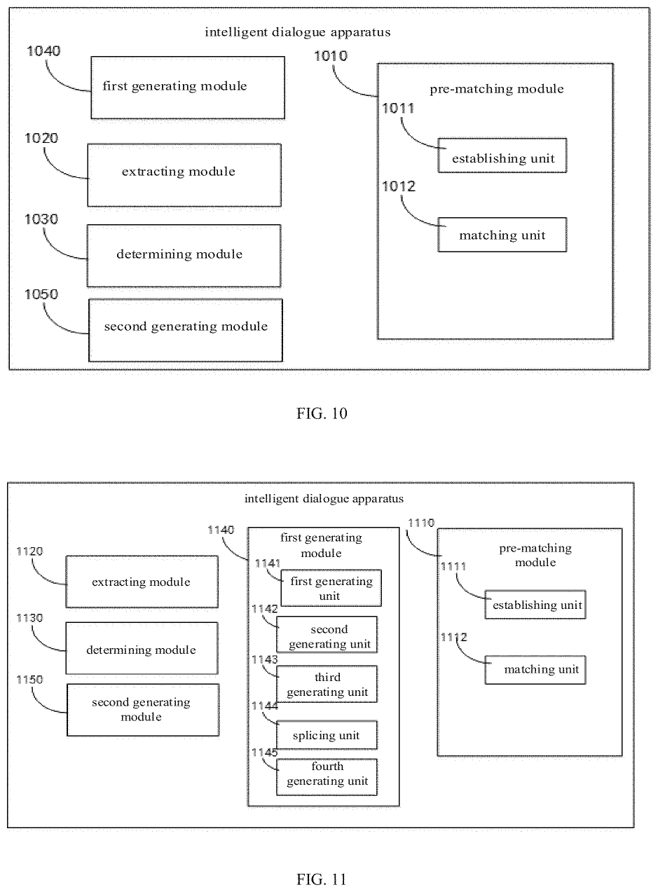

In an embodiment, as shown in FIG. 10, FIG. 10 is a block diagram of an intelligent dialogue apparatus according to an embodiment of the disclosure. The pre-matching module 1010 includes an establishing unit 1011 and a matching unit 1012.

The establishing unit 1011 is configured to establish a dictionary tree corresponding to the target table based on the plurality of column attributes in the target table and the attribute value of each column attribute. Each node in the dictionary tree includes a matching type, a matching level and a complete character string corresponding to the node.

The matching unit 1012 is configured to obtain the pre-matching result by performing the pre-matching on the query based on the dictionary tree. In a possible implementation, the matching unit 1012 is further configured to: perform a matching operation backwards on the dictionary tree starting with a character in the query, until the matching operation is unable to continue, and obtain the maximum matching character string interval starting from the character and a corresponding matching level; obtain an overlapping character string interval list and a corresponding matching level list after completing the matching operation for each character of the query; obtain a non-overlapping maximum coverage interval list corresponding to each matching level by de-overlapping character string intervals corresponding to each matching level in descending order of the matching level; and obtain the pre-matching result based on the non-overlapping maximum coverage interval list corresponding to each matching level.

Blocks 1020-1050 in FIGS. 10 and 920-950 in FIG. 9 have the same function and structure.

In an embodiment, as shown in FIG. 11, FIG. 11 is a block diagram of an intelligent dialogue apparatus according to an embodiment of the disclosure. In the intelligent dialogue apparatus, the first generating module 1140 includes: a first generating unit 1141, a second generating unit 1142, a third generating unit 1143, a splicing unit 1144, and a fourth generating unit 1145.

The first generating unit 1141 is configured to generate a feature vector of each column attribute based on the attribute name of each column attribute, the highest matching level of the attribute name, the highest matching level of the attribute value and the target attribute value.

The second generating unit 1142 is configured to generate a feature vector of the query and a feature vector of each character of the query based on the query.

The third generating unit 1143 is configured to generate a global feature vector of the query based on the feature vector of the query and the feature vector of each character through an attention mechanism. The third generating unit 1143 is further configured to: generate an attention feature vector based on the feature vector of the query and the feature vector of each character based on the attention mechanism; and generate the global feature vector of the query based on the feature vector of the query and the attention feature vector.

The splicing unit 1144 is configured to obtain a splicing feature vector by splicing the feature vector of each character with the feature vector of each column attribute.

The fourth generating unit 1145 is configured to obtain the SQL query statement corresponding to the query by inputting the feature vector of each column attribute, the global feature vector and the splicing feature vector into a SQL statement generation model. The SQL statement generation model includes a query field subtask, a query field determination condition subtask, a query field determination condition symbol subtask, a query field determination condition quantity subtask, a query field aggregation function subtask, a query quantity subtask, a problem determination condition quantity subtask, a sequence labeling subtask, and a determination condition logical connector subtask.

In a possible implementation, the fourth generating unit 1145 is configured to: obtain a first prediction result of each column attribute by predicting the feature vector of each column attribute based on the query field subtask; obtain a second prediction result of each column attribute by predicting the feature vector of each column attribute based on the query field determination condition subtask; obtain a third prediction result of each column attribute by predicting the feature vector of each column attribute based on the query field determination condition symbol subtask; obtain a fourth prediction result of each column attribute by predicting the feature vector of each column attribute based on the query field determination condition quantity subtask; obtain a fifth prediction result of each column attribute by predicting the feature vector of each column attribute based on the query field aggregation function subtask; obtain a sixth prediction result by predicting the global feature vector based on the query quantity subtask; obtain a seventh prediction result by predicting the global feature vector based on the problem determination condition quantity subtask; obtain an eighth prediction result by predicting the global feature vector based on the determination condition logical connector subtask; obtain a ninth prediction result by predicting the splicing feature vector based on the sequence labeling subtask; and generate the SQL query statement corresponding to the query based on the first prediction result, the second prediction result, the third prediction result, the fourth prediction result, the fifth prediction result, the sixth prediction result, the seventh prediction result, the eighth prediction result and the ninth prediction result.

Optionally, in an embodiment, when the fourth generating unit generates the SQL query statement corresponding to the query based on the first prediction result, the second prediction result, the third prediction result, the fourth prediction result, the fifth prediction result, the sixth prediction result, the seventh prediction result, the eighth prediction result and the ninth prediction result, the fourth generating unit 1145 is further configured to: determine a candidate query value of each column attribute based on the ninth prediction result; determine a number of values of each column attribute based on the fourth prediction result and the ninth prediction result; determine a target query value of each column attribute based on the number of values and the candidate query value of each column attribute; determine a number of select and a corresponding select column list based on the first prediction result and the sixth prediction result; determine a number of where and a corresponding where column list based on the second prediction result and the seventh prediction result; determine a where column condition character based on the third prediction result; determine a select column aggregation function based on the fifth prediction result; determine a logical connector of the where column based on the eighth prediction result; and generate the SQL query statement corresponding to the query based on the target query value of each column attribute, the number of select and the select column list, the number of where and the where column list, the where column condition character, the select column aggregation function, and the logical connector of the where column.

Blocks 1110-1150 in FIGS. 11 and 1010-1050 in FIG. 10 have the same function and structure.

With the apparatus in the above embodiments, the specific manner in which each module performs operations has been described in detail in the method embodiments, and will not be elaborated here.

According to the embodiments of the disclosure, the disclosure also provides an electronic device and a readable storage medium.

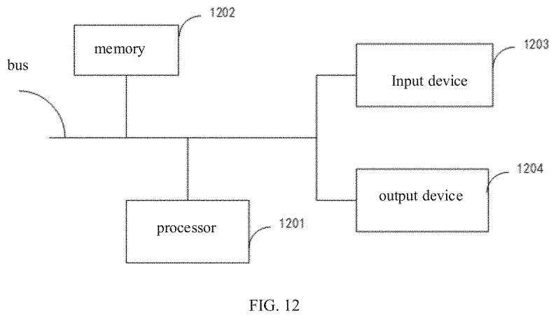

FIG. 12 is a block diagram of an electronic device configured to implement the intelligent dialogue method according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 12, the electronic device includes: one or more processors 1201, a memory 1202, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 1201 is taken as an example in FIG. 12.

The memory 1202 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 1202 is configured to store non-transitory software programs, non-transitory computer-executable programs and modules, such as program instructions/modules corresponding to the intelligent dialogue method according to the embodiments of the disclosure (for example, the pre-matching module 901, the extracting module 902, and the determining module 903 shown in FIG. 9). The processor 1201 executes various functional applications and data processing of the server by running the non-transitory software programs, instructions, and modules stored in the memory 1202, to implement the intelligent dialogue method in the above method embodiments.

The memory 1202 may include a storage program area and a storage data area, where the storage program area may store an operating system and application programs required for at least one function. The storage data area may store data created according to the use of the electronic device for implementing the method. In addition, the memory 1202 may include a high-speed random access memory, and a non-transitory memory, such as at least one magnetic disk storage device, a flash memory device, or other non-transitory solid-state storage device. In some embodiments, the memory 1202 may optionally include a memory remotely disposed with respect to the processor 1201, and these remote memories may be connected to the electronic device for implementing the method through a network. Examples of the above network include, but are not limited to, the Internet, an intranet, a local area network, a mobile communication network, and combinations thereof.

The electronic device used to implement the method may further include: an input device 1203 and an output device 1204. The processor 1201, the memory 1202, the input device 1203, and the output device 1204 may be connected through a bus or in other manners. In FIG. 12, the connection through the bus is taken as an example.

The input device 1203 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 1204 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, intermediate computing components, or front-end components. The components of the system may be interconnected by any form or medium of digital data communication (e.g., a communication network). Examples of communication networks include: a local area network (LAN), a wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

According to the technical solution of the embodiments of the disclosure, the NL2SQL technology has the generalization ability of column names and attribute names, so that the user's query can be completely matched with the column names or attribute names in the table, which improves the success rate of SQL analysis, improves the accuracy of database search results and enhances the effect of intelligent dialogue.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. An intelligent dialogue method, comprising:
obtaining a pre-matching result by pre-matching a query to be processed with a table content of a target table, wherein the target table comprises a plurality of column attributes and an attribute value of each column attribute, the pre-matching result comprises a highest matching level of an attribute name of each column attribute, a highest matching level of the attribute value, and an attribute value having a highest matching degree with the query;
extracting a character segment having a highest matching degree with the attribute value from the query based on the attribute value having the highest matching degree with the query;
determining a target attribute value semantically associated with the character segment based on the attribute value of each column attribute;
generating a structured query language (SQL) query statement corresponding to the query based on the query, the attribute name of each column attribute, the highest matching level of the attribute name, the highest matching level of the attribute value and the target attribute value; and
generating a reply statement based on a result obtained by searching a database based on the SQL query statement.

2. The method according to claim 1, wherein obtaining the pre-matching result by pre-matching the query to be processed with the table content of the target table comprises:
establishing a dictionary tree corresponding to the target table based on the plurality of column attributes in the target table and the attribute value of each column attribute, wherein each node in the dictionary tree comprises a matching type, a matching level and a complete character string corresponding to the node; and
obtaining the pre-matching result by performing the pre-matching on the query based on the dictionary tree.

3. The method according to claim 2, wherein obtaining the pre-matching result by performing pre-matching on the query based on the dictionary tree comprises:
performing a matching operation backwards on the dictionary tree starting with a character in the query, until the matching operation is unable to continue, and obtaining the maximum matching character string interval starting from the character and a corresponding matching level;
obtaining an overlapping character string interval list and a corresponding matching level list after completing the matching operation for each character of the query;
obtaining a non-overlapping maximum coverage interval list corresponding to each matching level by de-overlapping character string intervals corresponding to each matching level in descending order of the matching level; and
obtaining the pre-matching result based on the non-overlapping maximum coverage interval list corresponding to each matching level.

4. The method according to claim 1, wherein generating the SQL query statement corresponding to the query based on the query, the attribute name of each column attribute, the highest matching level of the attribute name, the highest matching level of the attribute value, and the target attribute value comprises:
generating a feature vector of each column attribute based on the attribute name of each column attribute, the highest matching level of the attribute name, the highest matching level of the attribute value and the target attribute value;
generating a feature vector of the query and a feature vector of each character of the query based on the query;
generating a global feature vector of the query based on the feature vector of the query and the feature vector of each character through an attention mechanism;
obtaining a splicing feature vector by splicing the feature vector of each character with the feature vector of each column attribute; and
obtaining the SQL query statement corresponding to the query by inputting the feature vector of each column attribute, the global feature vector and the splicing feature vector into a SQL statement generation model.

5. The method according to claim 4, wherein generating the global feature vector of the query based on the feature vector of the query and the feature vector of each character through the attention mechanism comprises:
generating an attention feature vector based on the feature vector of the query and the feature vector of each character based on the attention mechanism; and
generating the global feature vector of the query based on the feature vector of the query and the attention feature vector.

6. The method according to claim 4, wherein the SQL statement generation model comprises a query field subtask, a query field determination condition subtask, a query field determination condition symbol subtask, a query field determination condition quantity subtask, a query field aggregation function subtask, a query quantity subtask, a problem determination condition quantity subtask, a sequence labeling subtask, and a determination condition logical connector subtask.

7. The method according to claim 4, wherein obtaining the SQL query statement corresponding to the query by inputting the feature vector of each column attribute, the global feature vector and the splicing feature vector into the SQL statement generation model, comprises:
obtaining a first prediction result of each column attribute by predicting the feature vector of each column attribute based on the query field subtask;
obtaining a second prediction result of each column attribute by predicting the feature vector of each column attribute based on the query field determination condition subtask;
obtaining a third prediction result of each column attribute by predicting the feature vector of each column attribute based on the query field determination condition symbol subtask;
obtaining a fourth prediction result of each column attribute by predicting the feature vector of each column attribute based on the query field determination condition quantity subtask;
obtaining a fifth prediction result of each column attribute by predicting the feature vector of each column attribute based on the query field aggregation function subtask;
obtaining a sixth prediction result by predicting the global feature vector based on the query quantity subtask;
obtaining a seventh prediction result by predicting the global feature vector based on the problem determination condition quantity subtask;
obtaining an eighth prediction result by predicting the global feature vector based on the determination condition logical connector subtask;
obtaining a ninth prediction result by predicting the splicing feature vector based on the sequence labeling subtask; and
generating the SQL query statement corresponding to the query based on the first prediction result, the second prediction result, the third prediction result, the fourth prediction result, the fifth prediction result, the sixth prediction result, the seventh prediction result, the eighth prediction result and the ninth prediction result.

8. The method according claim 7, wherein generating the SQL query statement corresponding to the query based on the first prediction result, the second prediction result, the third prediction result, the fourth prediction result, the fifth prediction result, the sixth prediction result, the seventh prediction result, the eighth prediction result and the ninth prediction result, comprises:
determining a candidate query value of each column attribute based on the ninth prediction result;
determining a number of values of each column attribute based on the fourth prediction result and the ninth prediction result;
determining a target query value of each column attribute based on the number of values and the candidate query value of each column attribute;
determining a number of select and a corresponding select column list based on the first prediction result and the sixth prediction result;
determining a number of where and a corresponding where column list based on the second prediction result and the seventh prediction result;
determining a where column condition character based on the third prediction result;
determining a select column aggregation function based on the fifth prediction result;
determining a logical connector of the where column based on the eighth prediction result; and
generating the SQL query statement corresponding to the query based on the target query value of each column attribute, the number of select and the select column list, the number of where and the where column list, the where column condition character, the select column aggregation function, and the logical connector of the where column.

9. An intelligent dialogue apparatus, comprising:
one or more processors;
a memory storing instructions executable by the one or more processors;
wherein the one or more processors are configured to:
obtain a pre-matching result by pre-matching a query to be processed with a table content of a target table, wherein the target table comprises a plurality of column attributes and an attribute value of each column attribute, the pre-matching result comprises a highest matching level of an attribute name of each column attribute, a highest matching level of the attribute value, and an attribute value having a highest matching degree with the query;
extract a character segment having a highest matching degree with the attribute value from the query based on the attribute value having the highest matching degree with the query;
determine a target attribute value semantically associated with the character segment based on the attribute value of each column attribute;
generate a structured query language (SQL) query statement corresponding to the query based on the query, the attribute name of each column attribute, the highest matching level of the attribute name, the highest matching level of the attribute value and the target attribute value; and
generate a reply statement based on a result obtained by searching a database based on the SQL query statement.

10. The apparatus according to claim 9, wherein the one or more processors are configured to:
establish a dictionary tree corresponding to the target table based on the plurality of column attributes in the target table and the attribute value of each column attribute, wherein each node in the dictionary tree comprises a matching type, a matching level and a complete character string corresponding to the node; and
obtain the pre-matching result by performing the pre-matching on the query based on the dictionary tree.

11. The apparatus according to claim 10, wherein the one or more processors are configured to:
perform a matching operation backwards on the dictionary tree starting with a character in the query, until the matching operation is unable to continue, and obtain the maximum matching character string interval starting from the character and a corresponding matching level;
obtain an overlapping character string interval list and a corresponding matching level list after completing the matching operation for each character of the query;
obtain a non-overlapping maximum coverage interval list corresponding to each matching level by de-overlapping character string intervals corresponding to each matching level in descending order of the matching level; and
obtain the pre-matching result based on the non-overlapping maximum coverage interval list corresponding to each matching level.

12. The apparatus according to claim 9, wherein the one or more processors are configured to:
generate a feature vector of each column attribute based on the attribute name of each column attribute, the highest matching level of the attribute name, the highest matching level of the attribute value and the target attribute value;
generate a feature vector of the query and a feature vector of each character of the query based on the query;
generate a global feature vector of the query based on the feature vector of the query and the feature vector of each character through an attention mechanism;
obtain a splicing feature vector by splicing the feature vector of each character with the feature vector of each column attribute; and
obtain the SQL query statement corresponding to the query by inputting the feature vector of each column attribute, the global feature vector and the splicing feature vector into a SQL statement generation model.

13. The apparatus according to claim 12, wherein the one or more processors are configured to:
generate an attention feature vector based on the feature vector of the query and the feature vector of each character based on the attention mechanism; and
generate the global feature vector of the query based on the feature vector of the query and the attention feature vector.

14. The apparatus according to claim 12, wherein the SQL statement generation model comprises a query field subtask, a query field determination condition subtask, a query field determination condition symbol subtask, a query field determination condition quantity subtask, a query field aggregation function subtask, a query quantity subtask, a problem determination condition quantity subtask, a sequence labeling subtask, and a determination condition logical connector subtask.

15. The apparatus according to claim 12, wherein the one or more processors are configured to:
obtain a first prediction result of each column attribute by predicting the feature vector of each column attribute based on the query field subtask;
obtain a second prediction result of each column attribute by predicting the feature vector of each column attribute based on the query field determination condition subtask;
obtain a third prediction result of each column attribute by predicting the feature vector of each column attribute based on the query field determination condition symbol subtask;
obtain a fourth prediction result of each column attribute by predicting the feature vector of each column attribute based on the query field determination condition quantity subtask;
obtain a fifth prediction result of each column attribute by predicting the feature vector of each column attribute based on the query field aggregation function subtask;
obtain a sixth prediction result by predicting the global feature vector based on the query quantity subtask;
obtain a seventh prediction result by predicting the global feature vector based on the problem determination condition quantity subtask;
obtain an eighth prediction result by predicting the global feature vector based on the determination condition logical connector subtask;
obtain a ninth prediction result by predicting the splicing feature vector based on the sequence labeling subtask; and
generate the SQL query statement corresponding to the query based on the first prediction result, the second prediction result, the third prediction result, the fourth prediction result, the fifth prediction result, the sixth prediction result, the seventh prediction result, the eighth prediction result and the ninth prediction result.

16. The apparatus according claim 15, wherein the one or more processors are configured to:
determine a candidate query value of each column attribute based on the ninth prediction result;
determine a number of values of each column attribute based on the fourth prediction result and the ninth prediction result;
determine a target query value of each column attribute based on the number of values and the candidate query value of each column attribute;
determine a number of select and a corresponding select column list based on the first prediction result and the sixth prediction result;
determine a number of where and a corresponding where column list based on the second prediction result and the seventh prediction result;
determine a where column condition character based on the third prediction result;
determine a select column aggregation function based on the fifth prediction result;
determine a logical connector of the where column based on the eighth prediction result; and
generate the SQL query statement corresponding to the query based on the target query value of each column attribute, the number of select and the select column list, the number of where and the where column list, the where column condition character, the select column aggregation function, and the logical connector of the where column.

17. A non-transitory computer-readable storage medium storing computer instructions, wherein the computer instructions are configured to cause the computer to execute an intelligent dialogue method, the method comprises:
obtaining a pre-matching result by pre-matching a query to be processed with a table content of a target table, wherein the target table comprises a plurality of column attributes and an attribute value of each column attribute, the pre-matching result comprises a highest matching level of an attribute name of each column attribute, a highest matching level of the attribute value, and an attribute value having a highest matching degree with the query;
extracting a character segment having a highest matching degree with the attribute value from the query based on the attribute value having the highest matching degree with the query;
determining a target attribute value semantically associated with the character segment based on the attribute value of each column attribute;
generating a structured query language (SQL) query statement corresponding to the query based on the query, the attribute name of each column attribute, the highest matching level of the attribute name, the highest matching level of the attribute value and the target attribute value; and
generating a reply statement based on a result obtained by searching a database based on the SQL query statement.
